(19) United States
(12) Patent Application Publication
(10) Pub. No.: US 2025/0016187 A1
(43) Pub. Date: Jan. 9, 2025

(54) Contextual Data Processing Framework for Threat Intelligence, Detection, and Remediation

(71) Applicant: CONTEXTAL PROSTA SPÓLKA AKCYJNA, Torun (PL)

(72) Inventors: Tomasz Kojm, Torun (PL); Alberto Wu, Campodarsego (IT)

(73) Assignee: CONTEXTAL PROSTA SPÓLKA AKCYJNA, Torun (PL)

(21) Appl. No.: 18/347,671

(22) Filed: Jul. 6, 2023

(51) Int. Cl. H04L 9/40

(52) U.S. Cl. CPC H04L 63/1433; H04L 63/145

(57) ABSTRACT

A locally or remotely executing Contextual Data Processing Framework or plugin can be integrated with existing network infrastructures to enhance threat detection, intelligence, and remediation solutions. The Contextual Data Processing Framework can be deployed within the local infrastructure with one or more computing devices on one or more networks or may operate as a Software as a Service (SaaS) on a remote service for the local infrastructures. The Contextual Data Processing Framework leverages multiple stages that involve gathering local infrastructure data, processing, scanning, and contextualizing the gathered data, discovering relationships with other data, and then classifying data objects within recognized context and generating reports as necessary. The Contextual Data Processing Framework can be integrated with machine learning (ML) or artificial intelligence (AI) solutions to learn and automate the decisive processes.

### BACKGROUND

Malicious attacks and hacking attempts into computer systems, networks, and infrastructure continue to become more complex and, thereby, more challenging to detect and prevent. Bad actors, or black hats, have larger budgets for funding their activities, can be well-organized, and have sufficient QA (Quality Assurance) and test environments to make their threat attempts sophisticated.

In some scenarios, threat detection solutions may be obsolete and too rigid by focusing on unimportant details and utilizing wide-detection rules rather than understanding context and relationships. This can result in problems with stability, security, performance, and overall quality and threat recognition efficacy.

### SUMMARY

A locally or remotely executing Contextual Data Processing Framework can be integrated with existing network infrastructures to provide an enhanced threat detection solution. The Contextual Data Processing Framework can be deployed within the local infrastructure with one or more computing devices on one or more networks or may operate as a Software as a Service (SaaS) on a remote service for the local infrastructures. The Contextual Data Processing Framework leverages multiple stages that involve gathering local infrastructure data, processing, scanning, and contextualizing the gathered data, discovering relationships with other data, and then classifying data objects within the recognized context and generating reports as necessary. The local infrastructures can receive the reports and implement their own resolution, including blocking or otherwise remediating threats. References to a “local infrastructure” herein can include any one or more networks and one or more computing devices associated with an entity or a plurality of entities. Computing devices within the local infrastructure can include various computing devices like servers, virtual machines, cloud instances, laptop computers, personal computers, smartphones, tablet computers, smartwatches, HMD (head-mounted display) devices, and any other device that may receive data from another source, as any such data may be used as a threat to the local infrastructure's viability, such as malware, trojan horses, spoofing attacks, data leaks, etc. The local infrastructure's networks can include personal area networks, local area networks, wide area networks, and the Internet, and may include network devices such as routers, switches, access points, etc. As one example, the local infrastructure may be a company, university, government, or other organization. Although the term “local infrastructure” is used, this may also include devices operating remotely from each other.

Using a data processing and storage engine, the Contextual Data Processing Framework initially gathers various data from the local infrastructure, including e-mails, instant messages (IM), multimedia, container files such as ZIP or RAR files, network traffic (PCAP), and just about any other type or form of data available. The data processing and storage engine runs the received data through a format recognition engine that identifies each data's type and then forwards the recognized data types to dedicated data processing workers to analyze the data. The handlers process the received data objects to identify information and artifacts and label or associate each identified artifact and information as a “feature.” For example, the sender of an e-mail may be a feature, the date a file was created contained within the metadata may be a feature, and an identified password in a file may be a feature, among virtually any other piece of identified information. Such information can be collectively analyzed with other data objects to recognize patterns in the data. Upon identifying the features for each piece of data, the handlers build a tree or graph, if applicable, for each data object. For example, a container with sub-files or child objects can be built from the initial data object. A ZIP file may have multiple files that can be extracted from the initial ZIP file, such as PDFs, e-mails, and other identified data within the ZIP file. A PDF may have images, web links, malware, etc., that the handlers can identify with their inspection. Single files may have none or a limited number of child objects from the initial object, depending on the scenario.

After the data processing and storage engine builds the trees, it forwards the one or more built trees from the handlers to a data correlation and context detection engine (occasionally referred to herein as “context detection engine” for short). The context detection engine applies a set of feature-based rules to the various trees, or graphs, to identify patterns and glean information about threat detection. The feature-based rules could take different forms, such as computer programs, database queries, or utilize machine learning (ML) or artificial intelligence (AI) technologies, depending on the implementation of the Contextual Data Processing Framework. For example, the feature-based rules may include identifying similarities, direct relations, specific patterns, and other customized rules among the trees or within a single tree. For example, identifying distinct trees with a similar password within their data indicates that the threat may stem from a similar or the same party. E-mails from a common sender indicate that the threat stemmed from a common party. Any identified features within the graphs may be compared and assessed for similarities, relations, specific patterns, or otherwise satisfy some customized rule. Graphs may be periodically reprocessed to discover new relations with other graphs in the database.

Graphs flagged as satisfying the applied feature-based rules may be passed onto a classification and reporting engine (occasionally referred to herein as “classification engine” for short). The classification engine applies a set of classification rules, which are different from the feature-based rules applied by the context detection engine. Depending on the scenario, the classification rules may associate certain identified features as malicious, reportable, flaggable, or other monikers. The classifications are then transmitted to a computing device associated with the local infrastructure, such as an administrator, owner, or automated system, etc., for handling. For example, the administrator can work on investigating or remediating the threat, and the automated system can perform blocking and remediation actions without manual intervention. If the flagged graphs are found to contain additional information, which could help to better process the data object, they can be transmitted back together with the object to the data processing and storage engine for reprocessing, such as the initial data may be reanalyzed by the format recognition engine and then reprocessed by the dedicated data handler.

The Contextual Data Processing Framework can help root out digital threats and learn over time by improving each engine, such as rules applied, the handler's capabilities for identifying features and increasing the analyzed data pool by continuing to add additional data to the collected data. The learning process could be further automated with the use of machine learning (ML) or artificial intelligence (AI) solutions. Such capabilities enable the Contextual Data Processing Framework to learn from multiple local infrastructures' events so that threats are analyzed and caught more swiftly. The Contextual Data Processing Framework thereby enhances the security for local network infrastructures within each infrastructure's computing devices and network and enables administrators and automated systems to identify, destroy, and patch such threats efficiently. Additionally, the modular design of the Contextual Data Processing Framework comprising of the data processing, context detection and classification engines, which all can be fully customized with the use of dedicated data handlers, rules, and algorithms enables users to adjust it to any specific needs or requirements.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative diagram of a high-level architecture of a Contextual Data Processing Framework's processes;

FIG. 2 shows an illustrative representation of the Contextual Data Processing Framework operating locally or remotely to a local infrastructure;

FIG. 3 shows an illustrative representation of collected data being analyzed and processed in a data processing and storage engine;

FIG. 4 shows an illustrative diagram in which the handler identifies features for each piece of information and artifact within a given data object;

FIG. 5 shows an illustrative schema of exemplary feature associations within data objects;

FIG. 6 shows an illustrative representation in which the data handler generates a tree or graph for features associated with a given data object and its child objects;

FIG. 7 shows an illustrative representation of a generated graph;

FIG. 8 shows an illustrative representation of a generated graph;

FIG. 9 shows an illustrative representation in which the generated graphs are passed to a graph database for local or remote;

FIG. 10 shows an illustrative representation in which feature-based rules are applied to the graphs within the graph database;

FIG. 11 shows an illustrative representation in which graphs that satisfy the applied rules are passed onto a classification and reporting engine;

FIG. 12 shows an illustrative representation in which a set of classification rules are applied to the graphs that satisfied the feature-based rules;

FIGS. 13 and 14 show illustrative processes that may be performed by one or more of a local or remote computing device or remote service;

FIG. 15 is a simplified block diagram of an illustrative architecture of a computing device that may be used at least in part to implement the present advanced context binding of data for threat intelligence, detection, and remediation; and

FIG. 16 is a simplified block diagram of an illustrative remote computing device, remote service, or computer system that may be used in part to implement the present advanced context binding of data for threat intelligence, detection, and remediation.

Like reference numerals indicate like elements in the drawings. Elements are not drawn to scale unless otherwise indicated.

### DETAILED DESCRIPTION

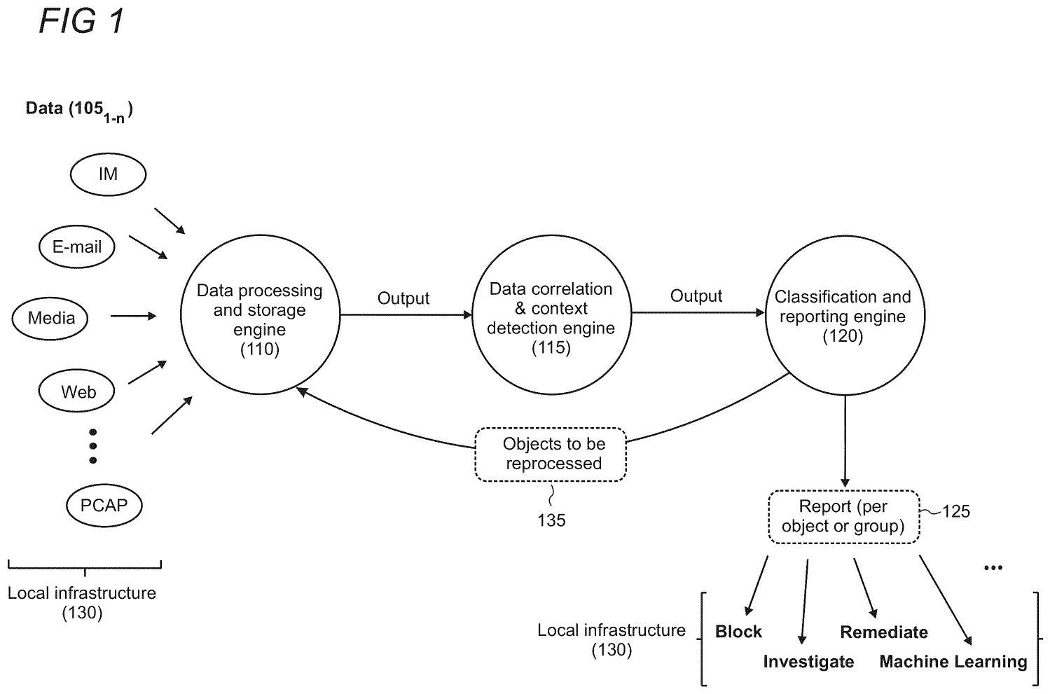

FIG. 1 shows an illustrative high-level diagram of processes and engines that a Contextual Data Processing Framework may execute as a threat detection system. Various data 105 are collected at a data processing and storage engine 110 (occasionally referred to herein as “data collection engine” for short). Such data can include an IM (instant message), e-mail, media (e.g., audio, video, photographs, etc.), web links, and PCAP (network packet capture), which may be obtained from a local infrastructure 130. Other forms of data not shown in FIG. 1 can include, for example, executable files, Microsoft Office documents, archives, disk images, and others.

The local infrastructure 130 may be the set of one or more computing devices and network devices associated with a given organization, such as a company, university, government body, residence, etc. The local infrastructure can be a small entity, such as a single computing device at some local residential address, or a larger organization. Computing devices within the local infrastructure can include various computing devices like servers, virtual machines, cloud instances, laptop computers, personal computers, smartphones, tablet computers, smartwatches, HMD (head-mounted display) devices, and any other device that may receive data from another source, as any such data may be used as a threat to the local infrastructure's viability, such as malware, trojan horses, spoofing attacks, data leaks, etc. The local infrastructure's networks can include personal area networks, local area networks, wide area networks, and the Internet, and may include network devices such as routers, switches, access points, etc.

The data processing engine 110 performs various processes on the data, such as a format recognition engine to identify a data format for a piece of data, and then a handler identifies features for a data object and generates a graph on a per-object basis. The generated tree or graph is passed to a data correlation and context detection engine (occasionally referred to herein as “context detection engine” for short) (115), which applies a set of feature-based rules to identify features for information and artifacts within a given data object. The feature-based rules may identify, for example, graphs with similarities, direct relations, specific patterns, or satisfy some other customized rules to flag a graph or multiple graphs. The graphs that satisfy any of the feature-based rules are then passed onto a classification and reporting engine (120) (occasionally referred to herein as a “classification engine” for short), which applies a set of classification rules to determine if any of the identified graphs from the context detection engine should be flagged for reporting to a computing device or administrator for the local infrastructure. Graphs that are flagged enable the local infrastructure administrator, owner, or automated system to investigate, remediate, block, etc., the flagged data associated with the graph. The gathered information could be also utilized for machine learning (ML) or artificial intelligence (AI) purposes to further automate such actions in the future.

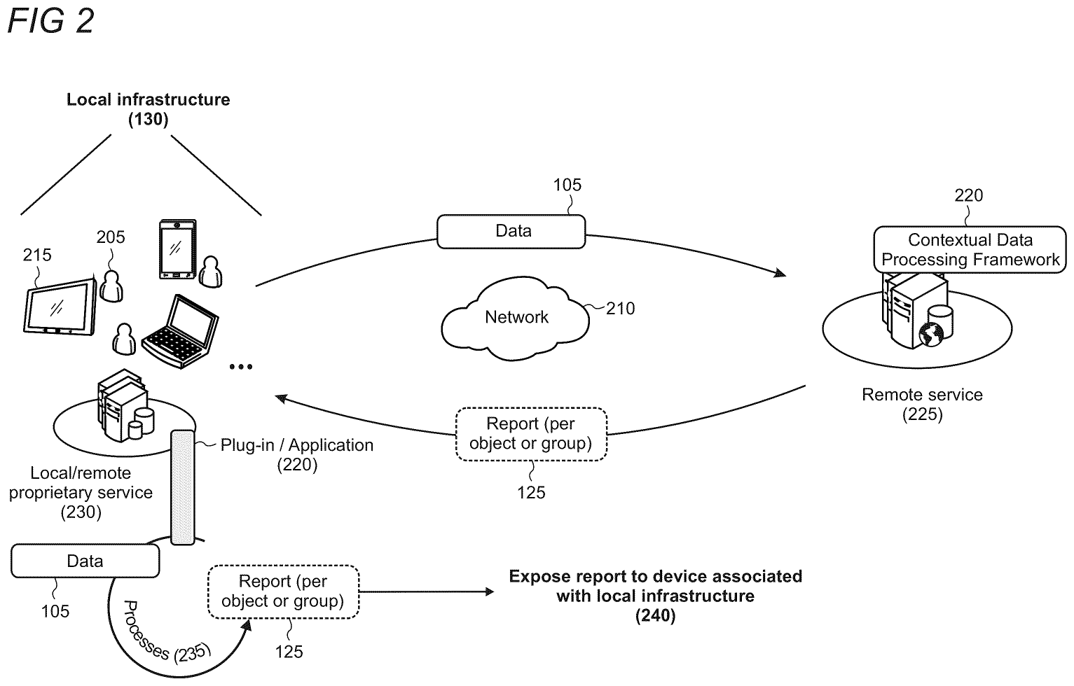

FIG. 2 shows an illustrative representation in which the local infrastructure's computing devices 215 and one or more local or remote proprietary services 230 forward object data 105 to a remote service 225 operating a Contextual Data Processing Framework 220. Alternatively, or additionally, the local computing devices 215 associated with the local infrastructure may forward their data to a local or remote proprietary service 230 that performs the operations of the Contextual Data Processing Framework 220. Thus, the operations of the Contextual Data Processing Framework may be performed locally on or remotely from a local infrastructure. For example, the remote operations at the remote service 225 may be a Saas (Software as a Service). The locally executing Contextual Data Processing Framework or plugin 220 may receive periodic updates from the remote service or alternatively may interoperate with the remotely executing Contextual Data Processing Framework. For example, data-gathering techniques may be performed within the local infrastructure to gather the local data and forward the gathered data to the Contextual Data Processing Framework for processing.

The remote service 225, upon executing the various processes and engines within its Contextual Data Processing Framework, forwards a report 125 to one or more computing devices within the local infrastructure. The report may be, for example, a structured JSON output, an e-mail message, instant message, text message, or notification and report prompted within a locally instantiated Contextual Data Processing Framework or plugin. Similarly, the local infrastructure's execution of a Contextual Data Processing Framework or plugin 220 processes 235 object data 105 and generates a like report 125. The report is exposed to a computing device 215 associated with the local infrastructure, such as an administrator's computing device or an automated system.

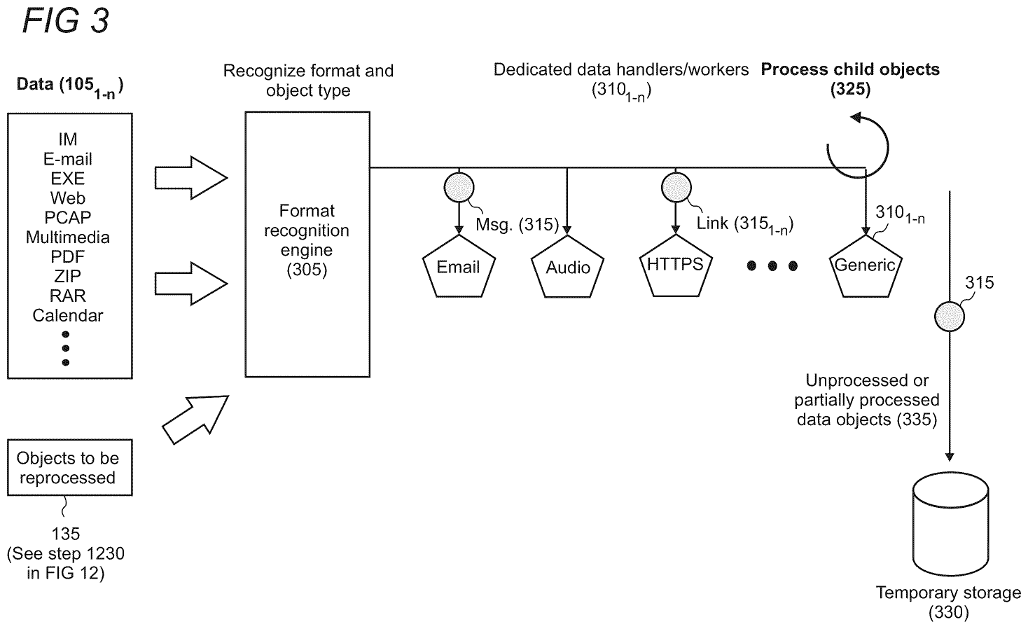

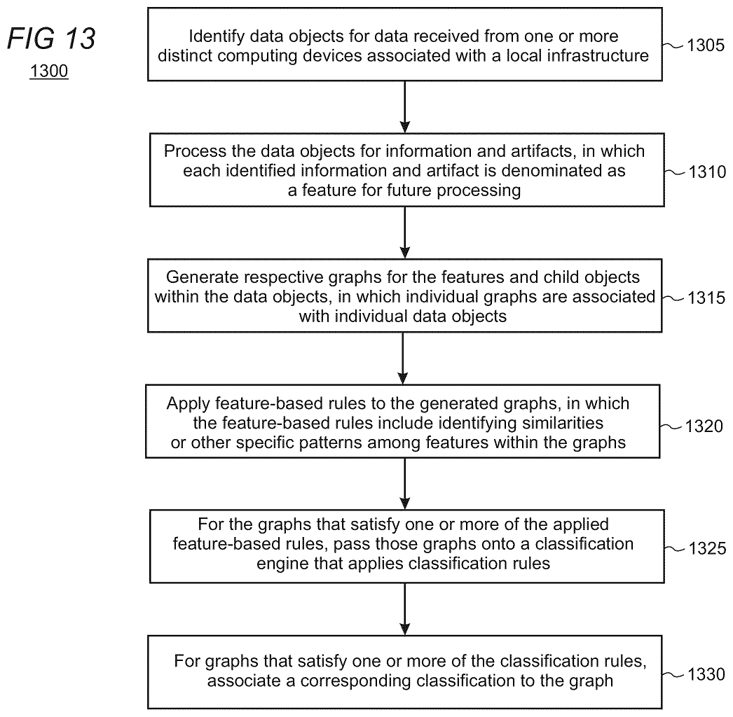

FIG. 3 shows an illustrative representation in which data 105 from the local infrastructure 130 is processed by a format recognition engine 305 that identifies the format of the received data, by analyzing the data structure, headers, and/or content in order to recognize characteristics of specific data types. Such processing may be performed by the data processing engine 110. For example, the format recognition engine 305, upon receiving potentially swaths of data, processes a piece of data, looks for common characteristics and identifies it as an e-mail message (e.g., an .eml file). Additionally, some objects may get reprocessed 135 and re-entered into the format recognition engine 305, as discussed in greater detail with respect to FIG. 12. Such processed data becomes a data object 315 that is forwarded to a dedicated data handler/worker 310. Each data handler is pre-configured to analyze and assess specific types of data objects. For example, data handlers may be pre-configured to analyze e-mail objects, audio objects, network traffic, etc. In some implementations, data handlers may be pre-configured to analyze multiple types of data objects. For example, the data handler may be generally pre-configured to analyze and process multiple types of data objects, and/or the data handler may be configured to handle an initial data object and any child data objects therein. For example, a data handler can analyze a ZIP file and any data objects stored therein, such as e-mails, PDFs, Microsoft Office documents, malware, etc.

A generic data handler may process data objects 315 without a dedicated pre-configured data handler 310. As discussed in greater detail below, any child objects (e.g., sub files) within a data object 315 may also be processed by a relevant data handler, as representatively shown by reference numeral 325. Thus, for example, a dedicated e-mail data handler may process an e-mail message and a child object PDF document may be processed by a dedicated PDF data handler. Although certain data handlers are shown in FIG. 3, other dedicated data handlers can include executable files, network traffic, JavaScript, disk images, and others.

In some scenarios, data handlers 310 may not be able to sufficiently analyze a received data object 315. In those situations, data objects are transmitted to temporary storage 330 for future processing. For example, if a data object is obfuscated, encrypted or password protected. Data objects that are unprocessed or partially processed 335 may be stored in temporary storage for reprocessing by a data handler at a later time, such as one or more days, weeks, months, years, etc. In some implementations, data objects that have been partially processed may move on through the various engines (FIG. 1) for at least a partial assessment.

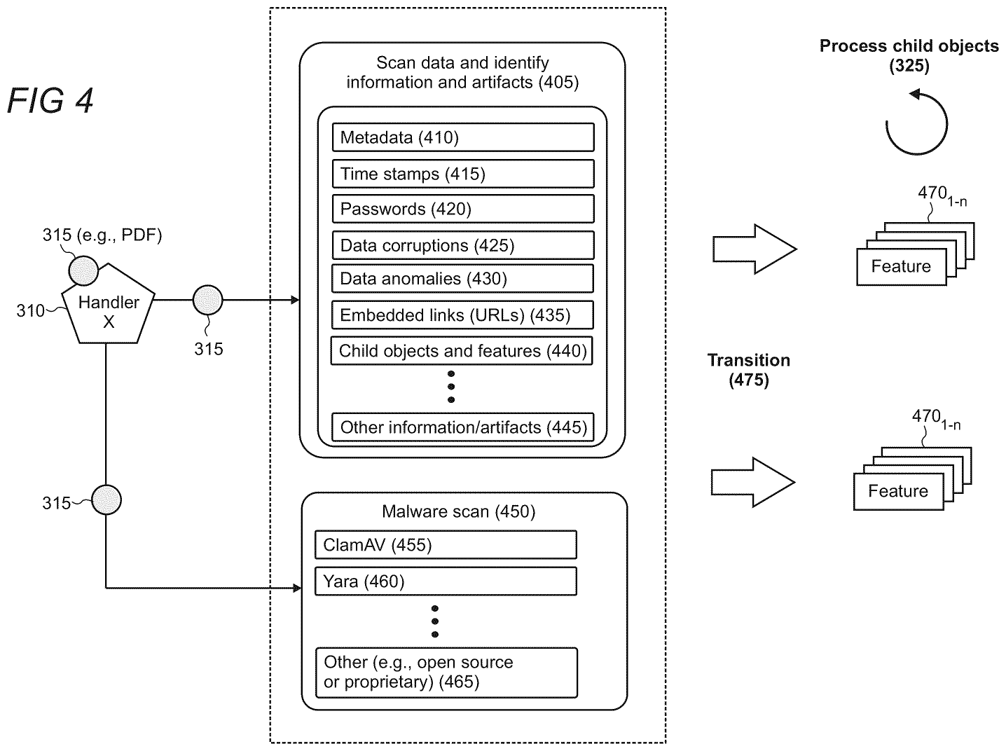

FIG. 4 shows an illustrative representation in which a specific handler 310 processes and identifies information and artifacts for each data object 315, as representatively illustrated by reference numeral 405. The moniker “Handler X” is used to represent any type of dedicated data handler. Each data handler is configured, for example, to analyze a given data object to identify metadata (e.g. list of files inside archive files) 310, time stamps 415, possible passwords (e.g., when a message contains a text like “This is the password to your file: abcd123”) 420, data corruptions (e.g., when a file is shorter than expected from the data specification) 425, data anomalies (e.g., when the data contains unexpected bytes) 430, embedded links (URLs (uniform resource locators)) 435, child objects and features 440 which may be any one or more of the processed data shown in FIG. 4 (e.g., metadata, passwords, etc.), and other information and artifacts 445.

Data handlers may additionally be configured to scan data objects 315 for malware 450. Such malware scans 450 may include utilizing ClamAV 455, Yara 460, or other open-source or proprietary malware scanning technology 465. The various scanning by the data handler may leverage one or more application programming interfaces (APIs) when performing the scans.

Upon the data handlers 315 processing the data objects 310, the identified information and artifacts, including any malware identified from the malware scan 450, are transitioned 475 into specific features 470. In typical implementations, each identified information or artifact is identified as a feature 470. As shown in FIG. 4 and with relation to FIG. 3, any additionally identified data objects 315 that are identifiable by the format recognition engine 305 may be reprocessed by a relevant data handler. For example, if a multimedia data object is identified from a container, such as a ZIP file, the dedicated multimedia data handler may be used to process the child object. In this situation, a proper and corresponding data handler may process each child object for information and artifacts.

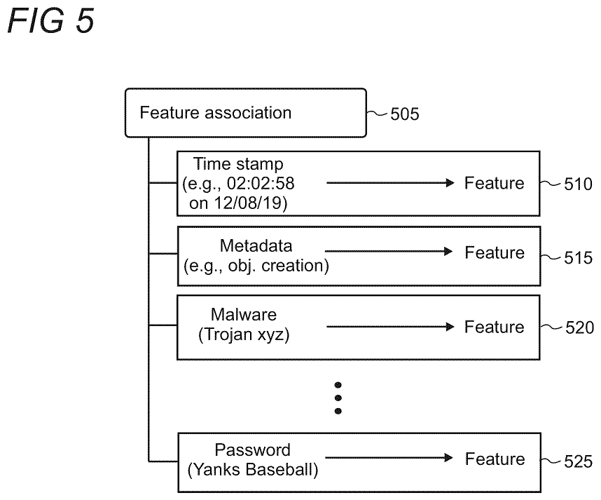

FIG. 5 shows an illustrative schema of exemplary features and feature association 505 for the identified information and artifacts performed by the data handler (FIG. 4). For example, exemplary and non-exhaustive feature associations include a time stamp for a data object or child object 510, metadata (e.g., object creation information) 515, malware 520, or a password 525. Parsing features for data objects provides the capability to understand pieces of data, glean intelligence, and root out digital threats.

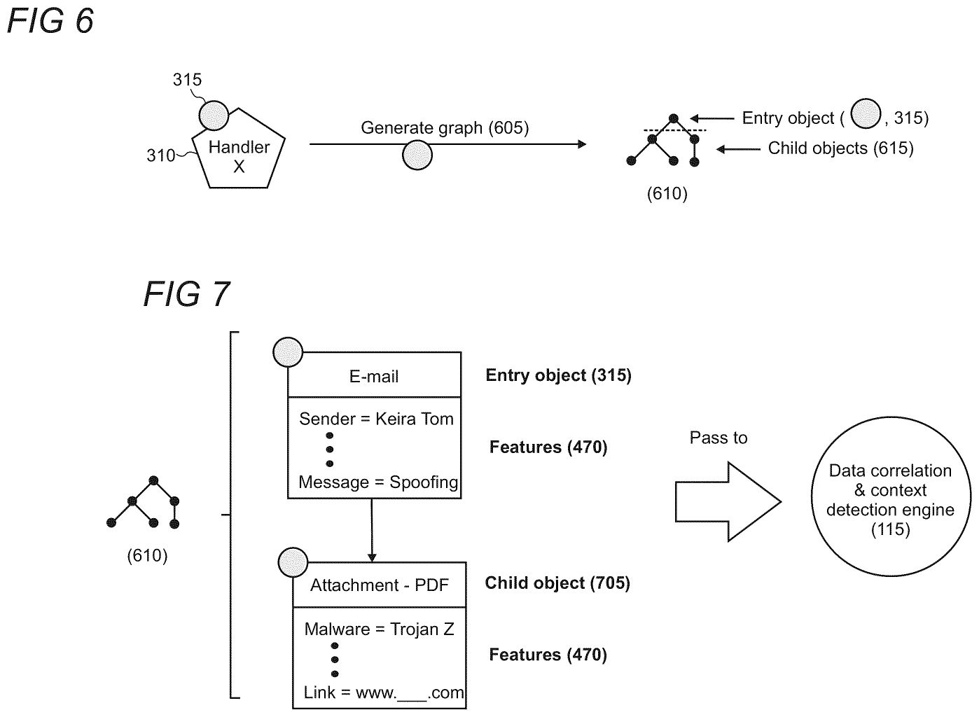

FIG. 6 shows an illustrative representation in which the data handler 310 generates a graph 610 for a given data object 315, as representatively illustrated by reference numeral 605. The graph or tree 610 starts with the initial data object 315, and may include any number of child objects 615. Child objects may be other data objects associated with an initial data object 315, such as if the data object 315 is an e-mail message, ZIP or RAR archive, and the like in which sub-files are present. The tree associates these child objects with the initial data object to further enable a full understanding of a given data object from the local infrastructure and make it possible to later compare it to other objects already processed by the Contextual Data Processing Framework.

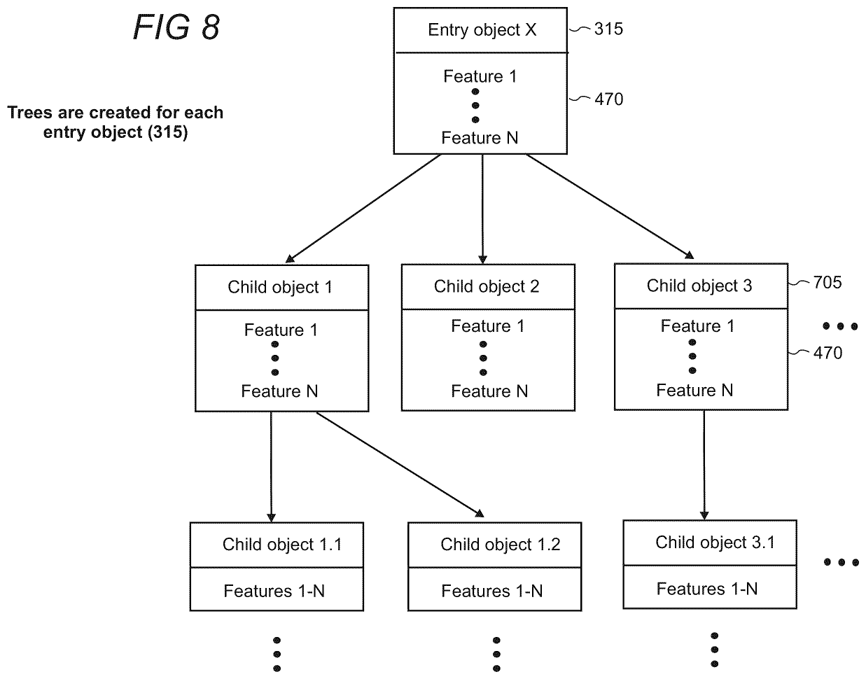

FIG. 7 shows an illustrative representation in which an exemplary graph 610 includes an entry object 315, its associated features 470 identified, and any number of child objects 705 and their associated features 470. As shown, the entry object's features can include the sender's information for an e-mail and an indication that a spoofing message header was present. A subfile, or child object 705, can include an attached PDF in the e-mail, and the PDF is identified as having malware and a link. Each generated graph 610 is passed onto the data correlation and context detection engine 115.

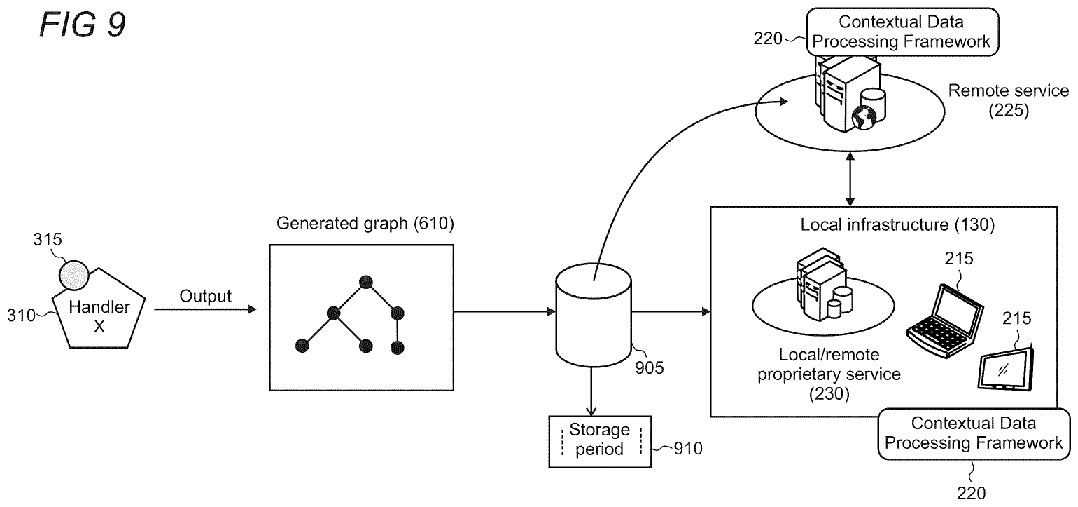

FIG. 8 shows an illustrative representation of an exemplary graph 610. The entry object 315 can have any number of features 470, and child objects are then further broken down. Additional rows of child objects can also be created if, for example, a child object depends on another child object. Any number of child objects is possible. Child objects may be other data objects identifiable by the format recognition engine 305 (FIG. 3). Thus, for example, if a container file, such as an e-mail, instant or text message, ZIP or RAR archive, etc., has other types of data objects (e.g., e-mails, multimedia, executable files, calendar invitations, PCAP, web links, etc.), then those data objects are considered child objects of the entry object and are also processed by the data handler's analysis operations for information and artifacts (FIG. 4).

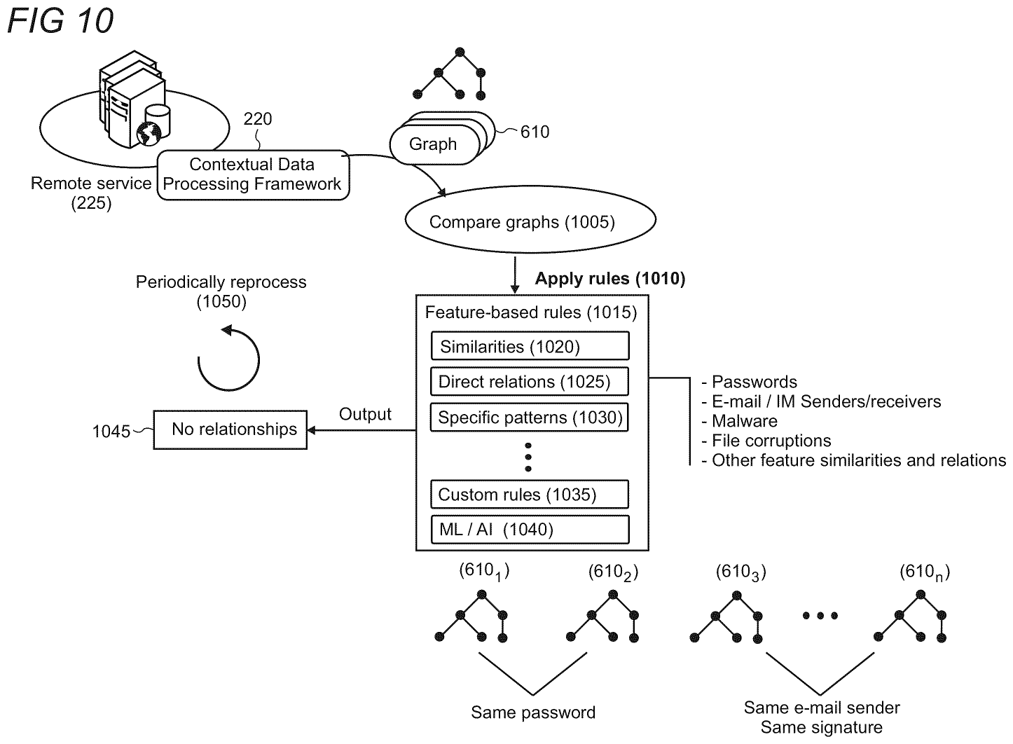

FIG. 9 shows an illustrative representation in which the generated graph 610 is output from the data handler and stored within a graph database 905. Each graph may be stored for a storage period 910, such as one or more days, weeks, months, years, etc. After the storage period expires or a given deletion date is reached for a given graph 610, the graph is deleted by some controlling computing device. The graphs in the graph database are accessible by one or each of the remote service 225 or a computing device within the local infrastructure 130, each of which utilizes the Contextual Data Processing Framework's features 220. In this regard, the various engines (FIG. 1) and operations discussed herein may be performed fully or partially by either the remote service 225 or a computing device within the local infrastructure, such as the local/remote proprietary service 230 or computing devices 215. Although the discussions herein reference the remote service processing the received data 130 from the local infrastructure's devices, other configurations are also possible so long as the Contextual Data Processing Framework's features are present.

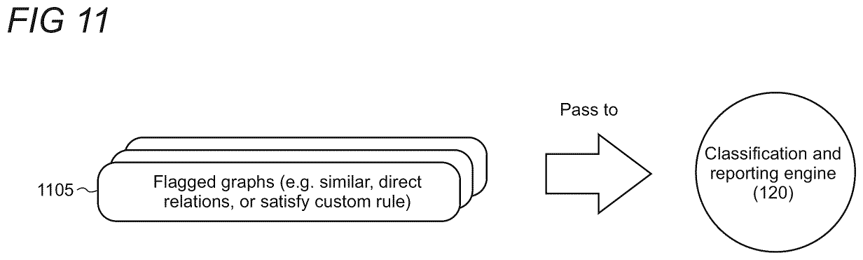

FIG. 10 shows an illustrative representation in which the remote service 225, using the Contextual Data Processing Framework 220, compares the graphs 610, as representatively shown by reference numeral 1005. This step may be performed as part of the context detection engine 115. Comparing the graphs includes applying feature-based rules 1010 to the various graphs, which includes identifying similarities among one or more graphs 1020, direct relations among one or more graphs 1025, specific patterns 1030, and any custom rules 1035 that cause the context detection engine to flag a graph. The feature-based rules 1010 could take different forms, such as computer programs, database queries, or utilize machine learning (ML) or artificial intelligence (AI) technologies 1040, depending on the implementation of the Contextual Data Processing Framework. Exemplary graph features that are compared or analyzed include passwords, e-mail or IM senders/receivers, malware, data corruptions, anomalies, and other feature similarities, relations, and specific patterns identified by the data handlers 310.

When ML or AI technologies are utilized, an ML/AI engine utilizes an algorithm to develop a predictive model based on perceived received data, third-party data, etc. The ML/AI engine ingests the data which may include other instances of data so the ML/AI engine can learn from past scenarios and characterizations. The ML/AI engine may clean, prepare, and manipulate the data. For example, the data may be randomized, to reduce the possibility of an order affecting the machine learning process, and separated, between a training set for training the model and a testing set for testing the trained model. Other forms of data manipulation may be performed as well, such as normalization, error correction, and the like. Such data preparation techniques enable the ML/AI engine to learn from prior scenarios how the dedicated data handlers process the data.

The ML/AI engine also trains and tests the model, respectively. The model training may be used to incrementally improve the model's ability to make accurate predictions. The model training may use the features contained in the data to form a matrix with weights and biases against the data. Random values within the data may be utilized to attempt prediction of the output based on those values. This process may repeat until a more accurate model is developed which can predict correct outputs. The model may subsequently be evaluated to determine if it meets some accuracy threshold (e.g., 70% or 80% accuracy), and then the predictive model will be deployed to make predictions.

While the ML/AI engine is one method by which the Contextual Data Processing Framework can develop learned models and predictions, other methods of pattern recognition are also possible. Such as using custom or pre-defined rules which causes the Contextual Data Processing Framework to automatically trigger some operation, whether those rules are based on feature-based rules (FIG. 10) or classification rules (FIG. 12).

Graphs 610 identified as having no relationships 1045 with other graphs and not satisfying any custom rules, may be periodically reprocessed 1050, meaning the context detection engine re-applies the feature-based rules 1015 to the one or more graphs. Graphs 610 may be compared and flagged as having the same password, same e-mail sender, same signature, etc., with another graph from the data. Although FIG. 10 provides some exemplary reasons to flag graphs, any of the features identified by the data handlers (FIGS. 4 and 5) may be used in the process.

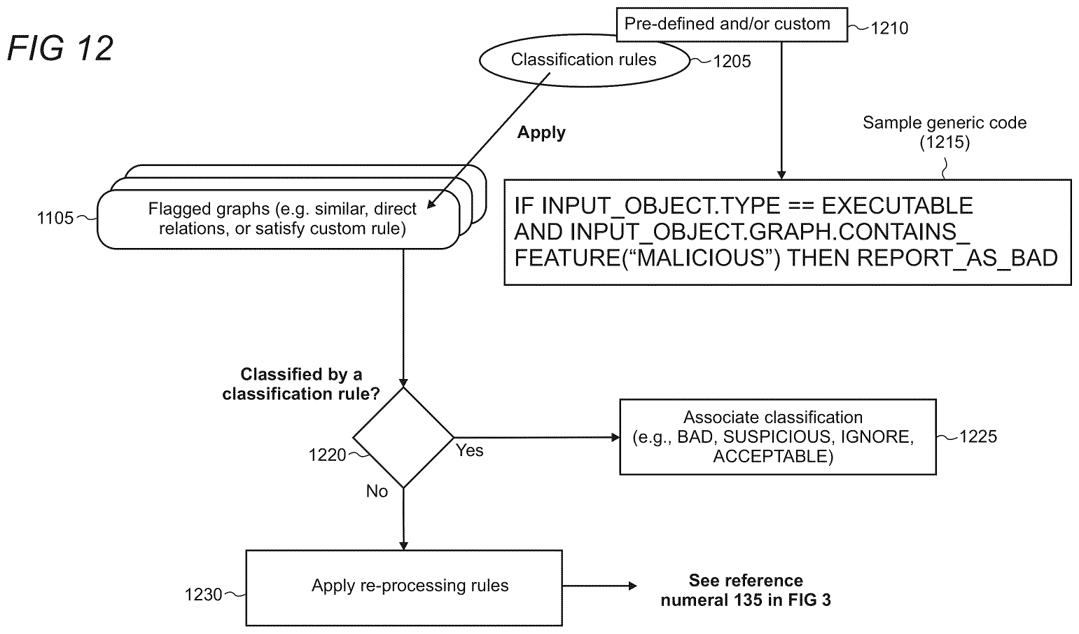

FIG. 11 shows an illustrative representation in which flagged graphs 1105 identified by the context detection engine 115 (FIG. 10) within the Contextual Data Processing Framework 230 are passed to a classification and reporting engine 120. Similar graphs, ones with some relation to one or more other graphs, or graphs that satisfy or meet one or more custom rules 1035, are passed forward to the classification engine for processing. If no relations are found, the graph generated for the input object is passed to the classification engine.

FIG. 12 shows an illustrative representation in which the classification rules 1205, from the classification engine 120 of the Contextual Data Processing Framework 220, are applied to the flagged graphs 1105 output from the context detection engine 115. The classification rules may be pre-defined or custom rules 1210. The rules could take different forms, such as computer programs, database queries, or utilize machine learning or artificial intelligence technologies, depending on the implementation of the Contextual Data Processing Framework. A sample generic code 1215 is provided for exemplary purposes that one skilled in the art would appreciate and understand when classifying flagged graphs.

At step 1220, the classification engine 120 determines whether a graph 610 is classified by a classification rule 1205. The flagged graphs 1105 may be individually or collectively run through the classification engine such that each graph or the group of graphs is assessed as to whether it satisfies one of the classification rules. If a graph satisfies a classification rule, then the classification engine classifies and associates a moniker with the graph, such as BAD, SUSPICIOUS, IGNORE, ACCEPTABLE, etc., as representatively shown by step 1225. Such associated classification is then reported back to a computing device 215 associated with the local infrastructure 130 so an administrator, owner, security expert, or automated system can block, investigate, assess, and/or remediate the digital threat, if necessary. Such remediating steps can include deleting the data object, blocking future senders who transmitted the data object, etc. The reports can be also used for threat intelligence purposes to better understand the nature and context of the attacks.

Exemplary and non-exhaustive classification rules 1205 can include checking for the presence of features or their combinations across the flagged graphs 1105 or indicating the presence of malicious data, a potential attack, data leak, data compromise, exploits, and other potential threats. The classification rules 1205 can also indicate the flagged graphs 1105 are associated with the object data that should be considered harmless. The classification rules 1205 could take different forms, such as computer programs, database queries, or utilize machine learning or artificial intelligence technologies, depending on the implementation of the Contextual Data Processing Framework.

In scenarios in which graph 610 goes through the reprocessing rules 1230, and no decision is taken to reprocess the object data from scratch, the graph and its associated object may be denominated as UNCLASSIFIED and be reported as such along with its history through the Contextual Data Processing Framework 220. For example, a report may be generated for data that was processed by the Contextual Data Processing Framework, including its identified features from the data processing engine 110, which feature-based rules it satisfied, if any, in the context detection engine 115, which classification rules it satisfied, if any, in the classification engine 120, and whether it was reprocessed. In this regard, virtually every stage through the Contextual Data Processing Framework may be recorded and stored in a database associated with the local infrastructure 130 or the remote service 225 for that specific data object for future reference or review.

If a graph 610 fails to satisfy any of the classification rules 1205, then the graphs may be reprocessed in step 1230. Reprocessing rules try to determine whether there are any features within flagged graphs 1105 that would allow to gather more information about the object data, for example, in the case the object data is encrypted and the flagged graphs 1105 contain features indicating a possible decryption key, the rules could instruct the Contextual Data Processing Framework 220 to reprocess the graph and the associated object data in step 135 (FIG. 3) as an original piece of data, processing it through the format recognition engine 305 and data handlers 310, and continuing through the processes by the Contextual Data Processing Framework 220 again, but this time the additional information could allow proper decryption of the object data.

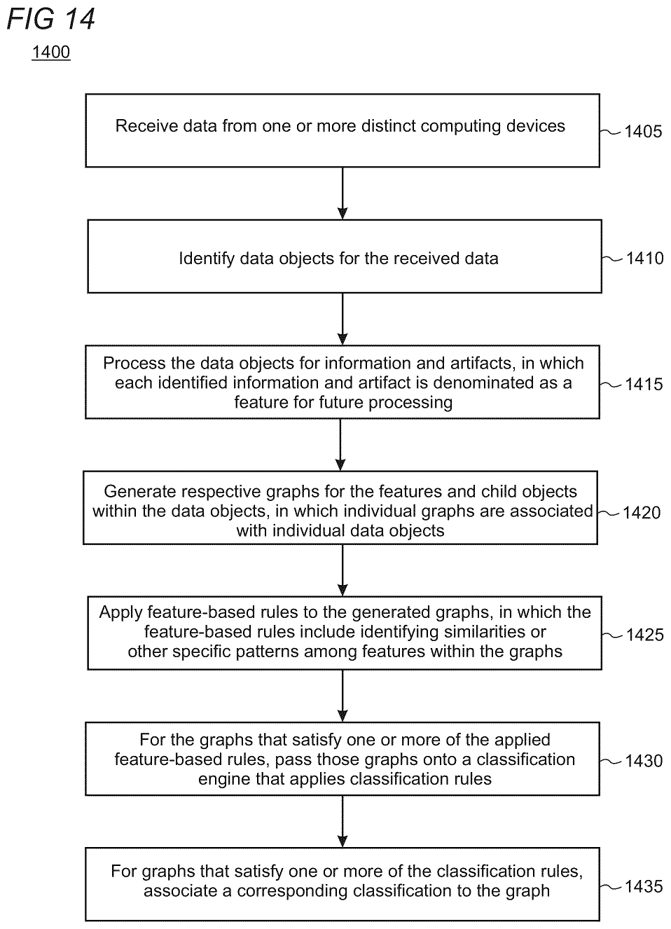

FIGS. 13 and 14 show illustrative methods in flowchart-form, which may be performed by one or more communication applications instantiated on participant computing devices, instantiated on the remote host service, or a combination thereof. The actions may be performed on multiple devices, by a single device, or by the host service which affects the session for all participants. The method's steps are exemplary and other variations of the steps are also possible. Furthermore, discussion of a “device” performing a step can include one or more computing devices or remote services, each device, or the remote service.

In step 1305, in FIG. 13, a computing device identifies data objects for data received from one or more distinct computing devices associated with a local infrastructure. In step 1310, the computing device processes the data objects for information and artifacts, in which the information and artifacts are denominated as a feature for future processing. In step 1315, the computing device generates respective graphs for the features and child objects within the data objects, in which individual graphs are associated with individual data objects. In step 1320, the computing device applies feature-based rules to the generated graphs, in which the feature-based rules include identifying similarities among features within the graphs. In step 1325, for the graphs that satisfy one or more of the applied feature-based rules, the computing device passes those graphs onto a classification engine that applies classification rules. In step 1330, for graphs that satisfy one or more of the classification rules, the computing device associates a corresponding classification to a graph.

Regarding FIG. 14, in step 1405, a remote service receives data from one or more distinct computing devices. In step 1410, the remote service identifies data objects for the received data. In step 1415, the remote service processes the data objects for information and artifacts, in which each identified information and artifact is denominated as a feature for future processing. In step 1420, the remote service generates respective graphs for the features and child objects associated with each data object, in which individual graphs are associated with individual data objects. In step 1425, the remote service applies feature-based rules to the generated graphs, in which the feature-based rules include identifying similarities or other specific patterns among features within the graphs. In step 1430, for the graphs that satisfy one or more of the applied feature-based rules, the remote service passes those graphs onto a classification engine that applies classification rules. In step 1435, for graphs that satisfy one or more of the classification rules, the remote service associates a corresponding classification to the graph.

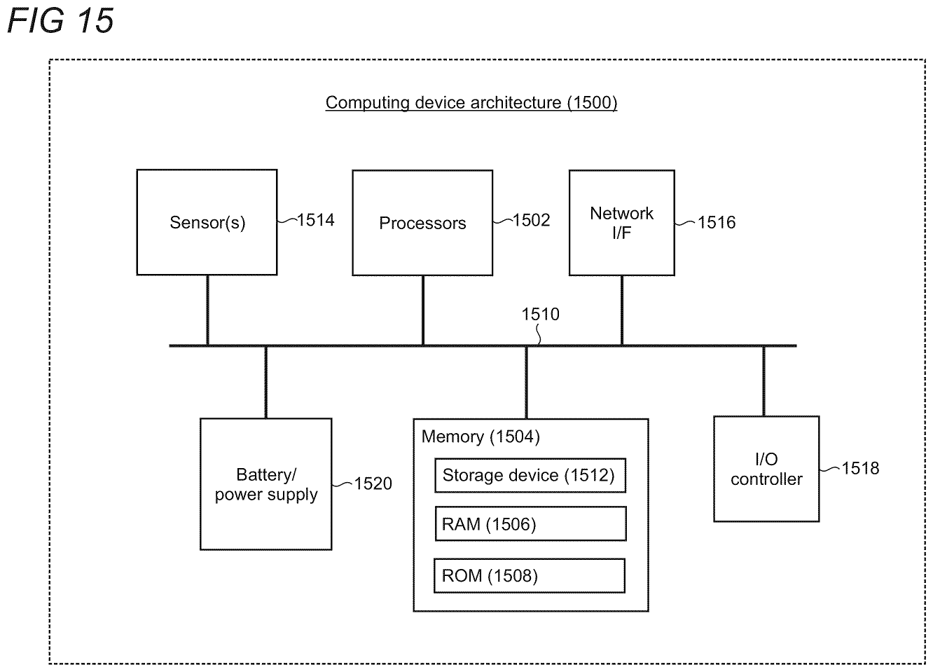

FIG. 15 shows an illustrative architecture 1500 for a device, such as a smartphone, tablet, laptop computer, or access device, capable of executing the various features described herein. The architecture 1500 illustrated in FIG. 15 includes one or more processors 1502 (e.g., central processing unit, dedicated AI chip, graphics processing unit, etc.), a system memory 1504, including RAM (random access memory) 1506, ROM (read-only memory) 1508, and long-term storage devices 1512. The system bus 1510 operatively and functionally couples the components in the architecture 1500. A basic input/output system containing the basic routines that help to transfer information between elements within the architecture 1500, such as during start-up, is typically stored in the ROM 1508. The architecture 1500 further includes a long-term storage device 1512 for storing software code or other computer-executed code that is utilized to implement applications, the file system, and the operating system. The storage device 1512 is connected to processor 1502 through a storage controller (not shown) connected to bus 1510. The storage device 1512 and its associated computer-readable storage media provide non-volatile storage for the architecture 1500. Although the description of computer-readable storage media contained herein refers to a long-term storage device, such as a hard disk or CD-ROM drive, it may be appreciated by those skilled in the art that computer-readable storage media can be any available storage media that can be accessed by the architecture 1500, including solid-state drives and flash memory.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read-only memory), EEPROM (electrically erasable programmable read-only memory), Flash memory or other solid-state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1500.

According to various embodiments, the architecture 1500 may operate in a networked environment using logical connections to remote computers through a network. The architecture 1500 may connect to the network through a network interface unit 1516 connected to the bus 1510. It may be appreciated that the network interface unit 1516 also may be utilized to connect to other types of networks and remote computer systems. The architecture 1500 also may include an input/output controller 1518 for receiving and processing input from a number of other devices, including a keyboard, mouse, touchpad, touchscreen, control devices such as buttons and switches or electronic stylus (not shown in FIG. 15). Similarly, the input/output controller 1518 may provide output to a display screen, user interface, a printer, or other type of output device (also not shown in FIG. 15).

It may be appreciated that any software components described herein may, when loaded into the processor 1502 and executed, transform the processor 1502 and the overall architecture 1500 from a general-purpose computing system into a special-purpose computing system customized to facilitate the functionality presented herein. The processor 1502 may be constructed from any number of transistors or other discrete circuit elements, which may individually or collectively assume any number of states. More specifically, the processor 1502 may operate as a finite-state machine, in response to executable instructions contained within the software modules disclosed herein. These computer-executable instructions may transform the processor 1502 by specifying how the processor 1502 transitions between states, thereby transforming the transistors or other discrete hardware elements constituting the processor 1502.

Encoding the software modules presented herein also may transform the physical structure of the computer-readable storage media presented herein. The specific transformation of physical structure may depend on various factors in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in architecture 1500 in order to store and execute the software components presented herein. It also may be appreciated that the architecture 1500 may include other types of computing devices, including wearable devices, handheld computers, embedded computer systems, smartphones, PDAs, and other types of computing devices known to those skilled in the art. It is also contemplated that the architecture 1500 may not include all of the components shown in FIG. 15, may include other components that are not explicitly shown in FIG. 15, or may utilize an architecture completely different from that shown in FIG. 15.

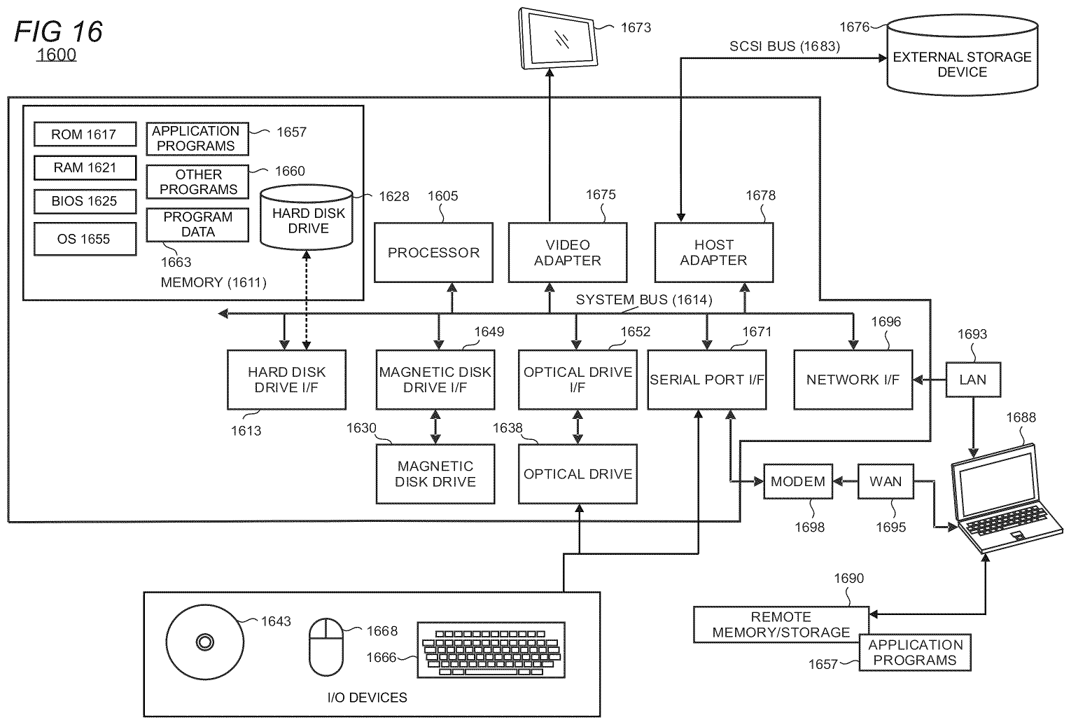

FIG. 16 is a simplified block diagram of an illustrative computer system 1600 such as a remote server, smartphone, tablet computer, laptop computer, or personal computer (PC) which the present disclosure may be implemented. Computer system 1600 includes a processor 1605, a system memory 1611, and a system bus 1614 that couples various system components, including the system memory 1611 to the processor 1605. The system bus 1614 may be any of several types of bus structures, including a memory bus or memory controller, a peripheral bus, or a local bus using any of a variety of bus architectures. The system memory 1611 includes read-only memory (ROM) 1617 and random access memory (RAM) 1621. A basic input/output system (BIOS) 1625, containing the basic routines that help to transfer information between elements within the computer system 1600, such as during start-up, is stored in ROM 1617. The computer system 1600 may further include a hard disk drive 1628 for reading from and writing to an internally disposed hard disk, a magnetic disk drive 1630 for reading from or writing to a removable magnetic disk (e.g., a floppy disk), and an optical disk drive 1638 for reading from or writing to a removable optical disk 1643 such as a CD (compact disc), DVD (digital versatile disc), or other optical media. The hard disk drive 1628, magnetic disk drive 1630, and optical disk drive 1638 are connected to the system bus 1614 by a hard disk drive interface 1646, a magnetic disk drive interface 1649, and an optical drive interface 1652, respectively. The drives and their associated computer-readable storage media provide non-volatile storage of computer-readable instructions, data structures, program modules, and other data for the computer system 1600. Although this illustrative example includes a hard disk, a removable magnetic disk 1633, and a removable optical disk 1643, other types of computer-readable storage media which can store data that is accessible by a computer such as magnetic cassettes, Flash memory cards, digital video disks, data cartridges, random access memories (RAMs), read-only memories (ROMs), and the like may also be used in some applications of the present disclosure. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, are intended to cover non-transitory embodiments, and does not include waves, signals, and/or other transitory and/or intangible communication media.

A number of program modules may be stored on the hard disk, magnetic disk, optical disk 1643, ROM 1617, or RAM 1621, including an operating system 1655, one or more application programs 1657, other program modules 1660, and program data 1663. A user may enter commands and information into the computer system 1600 through input devices such as a keyboard 1666, pointing device (e.g., mouse) 1668, or touchscreen display 1673. Other input devices may include a microphone, joystick, game pad, satellite dish, scanner, trackball, touchpad, touch-sensitive device, voice-command module or device, user motion or user gesture capture device, or the like. These and other input devices are often connected to the processor 1605 through a serial port interface 1671 that is coupled to the system bus 1614, but may be connected by other interfaces, such as a parallel port, game port, or universal serial bus (USB). A monitor 1673 or other type of display device is also connected to the system bus 1614 via an interface, such as a video adapter 1675. In addition to the monitor 1673, personal computers typically include other peripheral output devices (not shown), such as speakers and printers. The illustrative example shown in FIG. 16 also includes a host adapter 1678, a Small Computer System Interface (SCSI) bus 1683, and an external storage device 1676 connected to the SCSI bus 1683.

The computer system 1600 is operable in a networked environment using logical connections to one or more remote computers, such as a remote computer 1688. The remote computer 1688 may be selected as another personal computer, a server, a router, a network PC, a peer device, or other common network node, and typically includes many or all of the elements described above relative to the computer system 1600, although only a single representative remote memory/storage device 1690 is shown in FIG. 16. The logical connections depicted in FIG. 16 include a local area network (LAN) 1693 and a wide area network (WAN) 1695. Such networking environments are often deployed, for example, in offices, enterprise-wide computer networks, intranets, and the Internet.

When used in a LAN networking environment, the computer system 1600 is connected to the local area network 1693 through a network interface or adapter 1696. When used in a WAN networking environment, the computer system 1600 typically includes a broadband modem 1698, network gateway, or other means for establishing communications over the wide area network 1695, such as the Internet. The broadband modem 1698, which may be internal or external, is connected to the system bus 1614 via a serial port interface 1671. In a networked environment, program modules related to the computer system 1600, or portions thereof, may be stored in the remote memory storage device 1690. It is noted that the network connections shown in FIG. 16 are illustrative and other means of establishing a communications link between the computers may be used depending on the specific requirements of an application of the present disclosure.

Various exemplary embodiments are disclosed herein. In one exemplary embodiment, implemented is a computing device, comprising: one or more processors; and one or more hardware-based memory devices storing instructions which, when executed by the one or more processors, cause the computing device to: identify data objects for data received from one or more distinct computing devices associated with a local infrastructure; process the data objects for information and artifacts, in which each identified information and artifact is denominated as a feature for future processing; generate respective graphs for the features and child objects within the data objects, in which individual graphs are associated with individual data objects; apply feature-based rules to the generated graphs, in which the feature-based rules include identifying similarities or other specific patterns among features within the graphs; for the graphs that satisfy one or more of the applied feature-based rules, pass those graphs onto a classification engine that applies classification rules; and for the graphs that satisfy one or more of the classification rules, associate a corresponding classification to the graph.

In another example, the feature-based rules further includes identifying direct relations, similarities, or other specific patterns between graphs or determining whether graphs satisfy a customized rule. As another example, the data objects are identified using a format recognition engine that recognizes a data type for a given piece of data. In another example, the recognized data type for the data objects are forwarded to a dedicated data handler which is pre-configured to process a specifically identified data type for the data object. As another example, processing the data objects for information and artifacts includes performing a malware scan, in which results of scanning the data object are denominated as the feature. As another example, the generated graphs include the initially identified data object and child objects that are stored within or associated with the data object. In another example, child objects are processed by corresponding dedicated data handlers based on the child object's data type recognized by a format recognition engine.

In another exemplary embodiment, disclosed is a method performed by a remote service, comprising: receive data from one or more distinct computing devices; identify data objects for the received data; process the data objects for information and artifacts, in which each identified information and artifact is denominated as a feature for processing; generate respective graphs for the features and child objects associated with each data object, in which individual graphs are associated with individual data objects; apply feature-based rules to the generated graphs, in which the feature-based rules include identifying similarities, direct relations, or other specific patterns among features within the graphs; for the graphs that satisfy one or more of the applied feature-based rules, pass those graphs onto a classification engine that applies classification rules; and for the graphs that satisfy one or more of the classification rules, associate a corresponding classification to the graph.

As another example, the feature-based rules further includes identifying direct relations between graphs or determining whether graphs satisfy a customized rule, the data objects are identified using a format recognition engine that recognizes a data type for a given piece of data. In another example, the recognized data type for the data objects are forwarded to a data handler which is pre-configured to process one or more specifically identified data type for the data object. As another example, processing the data objects for information and artifacts includes performing a malware scan, in which malware identified within the data object are denominated as the feature. In another example, the generated graphs include the initially identified data object and child objects that are stored within or associated with the data object. As a further example, child objects are also respectively processed by capable data handlers based on the child object's data type recognized by a format recognition engine.

In another exemplary embodiment, disclosed is one or more hardware-based non-transitory computer-readable memory devices stored within a computing device, the memory devices including instructions which, when executed by one or more processors, cause the computing device to: identify data objects for data received from one or more distinct computing devices associated with a local infrastructure; process the data objects for information and artifacts, in which each identified information and artifact is denominated as a feature for future processing; generate respective graphs for the features and child objects within the data objects, in which individual graphs are associated with individual data objects; apply feature-based rules to the generated graphs, in which the feature-based rules includes identifying similarities, direct relations, or other specific patterns among features within the graphs; for the graphs that satisfy one or more of the applied feature-based rules, pass those graphs onto a classification engine that applies classification rules; and for the graphs that satisfy one or more of the classification rules, associate a corresponding classification to the graph.

In another example, the feature-based rules further includes identifying direct relations between graphs or determining whether graphs satisfy a customized rule. As another example, the data objects are identified using a format recognition engine that recognizes a data type for a given piece of data. As another example, the recognized data type for the data objects are forwarded to a dedicated data handler which is pre-configured to process a specifically identified data type for the data object. In another example, processing the data objects for information and artifacts includes performing a malware scan, in which results of scanning the data object are denominated as the feature. As another example, the generated graphs include the initially identified data object and child objects that are stored within or associated with the data object.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computing device, comprising:
one or more processors; and
one or more hardware-based memory devices storing instructions which, when executed by the one or more processors, cause the computing device to:
identify data objects for data received from one or more distinct computing devices associated with a local infrastructure;
process the data objects for information and artifacts, in which each identified information and artifact is denominated as a feature for future processing;
generate respective graphs for the features and child objects within the data objects, in which individual graphs are associated with individual data objects;
apply feature-based rules to the generated graphs, in which the feature-based rules include identifying similarities or other specific patterns among features within the graphs;
for the graphs that satisfy one or more of the applied feature-based rules, pass those graphs onto a classification engine that applies classification rules; and
for the graphs that satisfy one or more of the classification rules, associate a corresponding classification to the graph.

2. The computing device of claim 1, wherein the feature-based rules further includes identifying direct relations, similarities, or other specific patterns between graphs or determining whether graphs satisfy a customized rule.

3. The computing device of claim 1, wherein the data objects are identified using a format recognition engine that recognizes a data type for a given piece of data.

4. The computing device of claim 3, wherein the recognized data type for the data objects are forwarded to a dedicated data handler which is pre-configured to process a specifically identified data type for the data object.

5. The computing device of claim 1, wherein processing the data objects for information and artifacts includes performing a malware scan, in which results of scanning the data object are denominated as the feature.

6. The computing device of claim 1, wherein the generated graphs include the initially identified data object and child objects that are stored within or associated with the data object.

7. The computing device of claim 6, wherein child objects are processed by corresponding dedicated data handlers based on the child object's data type recognized by a format recognition engine.

8. A method performed by a remote service, comprising:
receive data from one or more distinct computing devices;
identify data objects for the received data;
process the data objects for information and artifacts, in which each identified information and artifact is denominated as a feature for processing;
generate respective graphs for the features and child objects associated with each data object, in which individual graphs are associated with individual data objects;
apply feature-based rules to the generated graphs, in which the feature-based rules include identifying similarities, direct relations, or other specific patterns among features within the graphs;
for the graphs that satisfy one or more of the applied feature-based rules, pass those graphs onto a classification engine that applies classification rules; and
for the graphs that satisfy one or more of the classification rules, associate a corresponding classification to the graph.

9. The method of claim 8, wherein the feature-based rules further includes identifying direct relations between graphs or determining whether graphs satisfy a customized rule.

10. The method of claim 8, wherein the data objects are identified using a format recognition engine that recognizes a data type for a given piece of data.

11. The method of claim 10, wherein the recognized data type for the data objects are forwarded to a data handler which is pre-configured to process one or more specifically identified data type for the data object.

12. The method of claim 8, wherein processing the data objects for information and artifacts includes performing a malware scan, in which malware identified within the data object are denominated as the feature.

13. The method of claim 8, wherein the generated graphs include the initially identified data object and child objects that are stored within or associated with the data object.

14. The method of claim 13, wherein child objects are also respectively processed by capable data handlers based on the child object's data type recognized by a format recognition engine.

15. One or more hardware-based non-transitory computer-readable memory devices stored within a computing device, the memory devices including instructions which, when executed by one or more processors, cause the computing device to:
identify data objects for data received from one or more distinct computing devices associated with a local infrastructure;
process the data objects for information and artifacts, in which each identified information and artifact is denominated as a feature for future processing;
generate respective graphs for the features and child objects within the data objects, in which individual graphs are associated with individual data objects;
apply feature-based rules to the generated graphs, in which the feature-based rules includes identifying similarities, direct relations, or other specific patterns among features within the graphs;
for the graphs that satisfy one or more of the applied feature-based rules, pass those graphs onto a classification engine that applies classification rules; and
for the graphs that satisfy one or more of the classification rules, associate a corresponding classification to the graph.

16. The one or more hardware-based non-transitory computer-readable memory devices of claim 15, wherein the feature-based rules further includes identifying direct relations between graphs or determining whether graphs satisfy a customized rule.

17. The one or more hardware-based non-transitory computer-readable memory devices of claim 15, wherein the data objects are identified using a format recognition engine that recognizes a data type for a given piece of data.

18. The one or more hardware-based non-transitory computer-readable memory devices of claim 17, wherein the recognized data type for the data objects are forwarded to a dedicated data handler which is pre-configured to process a specifically identified data type for the data object.

19. The one or more hardware-based non-transitory computer-readable memory devices of claim 15, wherein processing the data objects for information and artifacts includes performing a malware scan, in which results of scanning the data object are denominated as the feature.

20. The one or more hardware-based non-transitory computer-readable memory devices of claim 15, wherein the generated graphs include the initially identified data object and child objects that are stored within or associated with the data object.
